(19) United States
(12) Patent Application Publication
(10) Pub. No.: US 2017/0248941 A1
(43) Pub. Date: Aug. 31, 2017

(54) CELL CONTROLLER THAT DISPLAYS ABNORMALITY STATUS OF MANUFACTURING MACHINE FOR EACH AREA OR PROCESS

(71) Applicant: FANUC CORPORATION, Yamanashi (JP)

(72) Inventor: Soichi ARITA, Yamanashi (JP)

(21) Appl. No.: 15/428,089

(22) Filed: Feb. 8, 2017

(30) Foreign Application Priority Data
Feb. 26, 2016 (JP) 2016-035608

(51) Int. Cl. G05B 23/02; H04L 29/08

(52) U.S. Cl. CPC G05B 23/027; H04L 67/12; G05B 23/0275

(57) ABSTRACT

A cell controller of the present application includes: a machine information reception part that receives at least one of alarm information on manufacturing machines and status information on the manufacturing machines, and receives physical layout information on the manufacturing machines; a classification part that classifies the received physical layout information into a plurality of groups; and a display part that displays an abnormality status of the manufacturing machines for each of the groups of the classified physical layout information.

### BACKGROUND OF THE INVENTION

1. Field of the Invention

The present invention relates to a cell controller that controls a plurality of manufacturing machines based on production planning.

2. Description of the Related Art

In factories, parts are machined or welded using manufacturing machines such as a machine tool or a robot. The manufacturing machines constitute a manufacturing line, e.g., a manufacturing cell in order to manufacture products. In this case, the manufacturing machines constituting the manufacturing cell are controlled by a cell controller through network communications. The cell controller operates the manufacturing machines based on a production planning instruction from a host computer.

In such a manufacturing cell, manufacturing machines, such as robots, may not operate under abnormal conditions, leading to lower productivity. Thus, various methods have been proposed to quickly detect an abnormality of a manufacturing machine.

For example, Japanese Patent Application Laid-open No. 2004-202624 discloses a device for collecting information from a plurality of robots connected to a network. When a predetermined robot is out of order, the device compares registered robot information with individual robot information acquired in real time, thereby predicting a robot that is likely to go out of order. Japanese Patent Application Laid-open No. 2004-202624 also discloses extraction of candidates of parts required when the robot is out of order, based on information on the predicted robot.

In order to improve productivity, generally, the cause of an abnormality of a manufacturing machine needs to be quickly identified.

However, an abnormality of a manufacturing machine may be caused by various factors and thus the cause of an abnormality is not quickly identified with ease.

For example, in a large production facility, abnormalities may be caused by, for example, an area environment containing multiple manufacturing machines or operation conditions in each operation process performed by multiple manufacturing machines. Specifically, a manufacturing machine may be more likely to have a communication error in a specific area of a factory or may be more likely to fail in a specific operation process.

Under the circumstances, there exists no technique which can easily determine that an abnormality of a manufacturing machine is caused by an area environment or operation conditions as described above. Thus, it has been desired to develop a technique for such a determination.

The device disclosed in Japanese Patent Application Laid-open No. 2004-202624 predicts part failures of manufacturing machines such as a robot. However, the device does not have the function of detecting an abnormality of a manufacturing machine when the abnormality is caused by an area environment or operation conditions as described above.

### SUMMARY OF THE INVENTION

The present invention provides a cell controller that can easily determine that an abnormality of a manufacturing machine is caused by the environment of a specific area or the operation conditions of a specific operation process.

A first aspect of the present disclosure provides a cell controller that controls a plurality of manufacturing machines, the cell controller is connected so as to communicate with a host computer, wherein the cell controller including: a machine information reception part that receives at least one of alarm information on the manufacturing machines and status information on the manufacturing machines, and receives physical layout information on the manufacturing machines; a classification part that classifies the physical layout information received by the machine information reception part into a plurality of groups; and a display part that displays an abnormality status based on the alarm information or status information on the manufacturing machines, for each of the groups of the physical layout information classified by the classification part.

A second aspect of the present disclosure provides a cell controller that controls a plurality of manufacturing machines, the cell controller is connected so as to communicate with a host computer, wherein the cell controller including: a machine information reception part that receives at least one of alarm information on the manufacturing machines and status information on the manufacturing machines, and receives operation process information on the manufacturing machines; and a display part that displays an abnormality status based on the alarm information or status information on the manufacturing machines, for each operation process of the operation process information received by the machine information reception part.

A third aspect of the present disclosure provides a cell controller that controls a plurality of manufacturing machines, the cell controller is connected so as to communicate with a host computer, wherein the cell controller including: a machine information reception part that receives at least one of alarm information on the manufacturing machines and status information on the manufacturing machines; a physical layout-information setting part that sets physical layout information on the manufacturing machines; a classification part that classifies the physical layout information into a plurality of groups; and a display part that displays an abnormality status based on the alarm information or status information on the manufacturing machines, for each of the groups of the physical layout information classified by the classification part.

A fourth aspect of the present disclosure is a cell controller that controls a plurality of manufacturing machines, the cell controller is connected so as to communicate with a host computer, wherein the cell controller including: a machine information reception part that receives at least one of alarm information on the manufacturing machines and status information on the manufacturing machines; an operation process-information setting part that sets operation process information on the manufacturing machines; and a display part that displays an abnormality status based on the alarm information or status information on the manufacturing machines, for each operation process included in the operation process information.

A fifth aspect of the present disclosure provides, according to the cell controller of the first aspect or the third aspect, a cell controller including a warning output part that outputs a warning if the number of abnormalities or an incidence of abnormalities exceeds a predetermined threshold, wherein the number of abnormalities or the incidence of abnormalities indicates an abnormality status of the manufacturing machines for each of the groups of the classified physical layout information.

A sixth aspect of the present disclosure provides, according to the cell controller of the second aspect or the fourth aspect, a cell controller including a warning output part that outputs a warning if the number of abnormalities or an incidence of abnormalities exceeds a predetermined threshold, wherein the number of abnormalities or the incidence of abnormalities indicates an abnormality status of the manufacturing machines for each operation process included in the operation process information.

### BRIEF DESCRIPTION OF THE DRAWINGS

A detailed description of typical embodiments according to the present disclosure with reference to the accompanying drawings will further clarify the object, characteristics, and advantages of the present invention and other objects, characteristics, and advantages of the present invention.

FIG. 1 is a block diagram showing a production system including a cell controller according to a first embodiment;

FIG. 2A schematically shows an example of classification of physical layout information on manufacturing machines into a plurality of groups by a classification part;

FIG. 2B schematically shows another example of classification of the physical layout information on the manufacturing machines into a plurality of groups by the classification part;

FIG. 3 schematically shows an example of contents displayed on a display part in the classification of FIG. 2A;

FIG. 4 is a block diagram showing a production system including a cell controller according to a second embodiment;

FIG. 5 schematically shows an example of operation process information;

FIG. 6 schematically shows an example of contents displayed on the display part based on the operation process information shown in FIG. 5; and

FIG. 7 schematically shows the function of a cell controller according to another embodiment.

### DETAILED DESCRIPTION

Embodiments of the present disclosure will be described below with reference to the accompanying drawings. In the reference drawings, the same members and functional parts are indicated by the same reference numerals. To enhance understanding, the scales of the drawings are optionally changed. The illustrated embodiments show examples for implementing the present invention and do not limit the present invention.

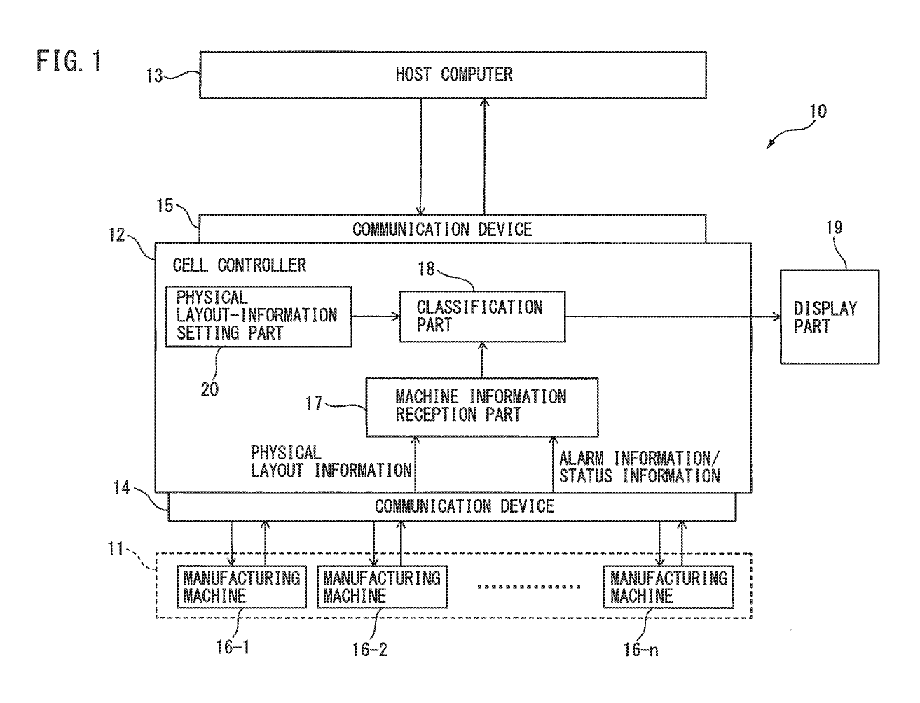

FIG. 1 is a block diagram showing a production system including a cell controller according to a first embodiment.

Referring to FIG. 1, a production system 10 includes at least one manufacturing cell 11, a cell controller 12, and a host computer 13.

The manufacturing cell 11 is installed in a factory for manufacturing products, whereas the cell controller 12 and the host computer 13 are located in a different building from the factory. For example, the cell controller 12 may be disposed in a different building in the area of the factory containing the manufacturing cell 11. In this case, the manufacturing cell 11 and the cell controller 12 are preferably connected to each other so as to communicate through a communication device 14, for example, an intranet network.

The host computer 13 may be located in an office remote from the factory. In this case, the cell controller 12 and the host computer 13 are preferably connected to each other so as to communicate through a communication device 15, for example, an internet network. The host computer 13 of the present embodiment is preferably a production planning device that produces manufacturing plans for the multiple manufacturing cells 11 or manufacturing machines in the office and manages the manufacturing conditions of the manufacturing cells 11 and manufacturing machines.

The manufacturing cell 11 is a group of manufacturing machines flexibly combined to manufacture products. As shown in FIG. 1, the manufacturing cell 11 of the present embodiment is composed of n manufacturing machines 16-1, 16-2, . . . and 16-n (n is a natural number). The number of manufacturing machines in the manufacturing cell 11 is not limited. The manufacturing cell 11 may be a manufacturing line where a workpiece is sequentially machined into a final product by the manufacturing machines. Alternatively, the manufacturing cell 11 may be a manufacturing line where at least two workpieces (parts) machined by at least two manufacturing machines are combined into a final product by another manufacturing machine during a manufacturing process. In the present embodiment, at least two workpieces machined by at least two manufacturing cells 11 may be combined into a final product.

The manufacturing machines 16-1 to 16-n may be numerically controlled machine tools, industrial robots, PLCs, conveyors, measuring apparatuses, testing devices, press machines, press-fitting devices, printers, die casting machines, injection molding machines, food machines, packaging machines, welders, washers, coating machines, assembly machines, mounters, woodworking machines, sealing devices, or cutters.

The cell controller 12 generates commands for the respective manufacturing machines 16-1 to 16-n based on a production planning instruction from the host computer 13 and then transmits the commands to the manufacturing machines. The manufacturing machines 16-1 to 16-n operate in response to the respective operation commands. The operation commands include commands based on the operation programs of the manufacturing machines 16-1 to 16-n.

Each of the cell controller 12 and the manufacturing machines 16-1 to 16-n is preferably configured with computer systems (not shown) which includes memories such as a ROM and a RAM, a CPU, and a communication control part, connected to one another via a bus. The communication control parts control data transfer between the cell controller 12 and the manufacturing machines 16-1 to 16-n. Moreover, the functions and operations of the cell controller 12 and the manufacturing machines 16-1 to 16-n are preferably obtained by executing programs using the CPUs of the cell controller 12 and the manufacturing machines 16-1 to 16-n, the programs is stored in the ROMs of the cell controller 12 and the manufacturing machines 16-1 to 16-n.

The configuration of the cell controller 12 according to the first embodiment will be specifically described below.

Referring to FIG. 1, the cell controller 12 of the first embodiment includes a machine information reception part 17, a classification part 18, and a display part 19 as basic constituent elements or units.

The machine information reception part 17 receives at least one of alarm information and status information on the manufacturing machines 16-1 to 16-n, and receives physical layout information on the manufacturing machines 16-1 to 16-n.

The classification part 18 classifies the received physical layout information on the manufacturing machines 16-1 to 16-n from the machine information reception part 17 into a plurality of groups.

The display part 19 displays an abnormality status of the manufacturing machines for each group of the classified physical layout information. The displayed abnormality status includes the number of abnormalities or the incidence of abnormalities of the manufacturing machines in each group, for example, the number of alarms or the incidence of alarms. Thus, the machine information reception part 17 preferably has the function of calculating the number of abnormalities or the incidence of abnormalities based on at least one of the received alarm information and status information. The calculation function may be provided for the manufacturing machines 16-1 to 16-n, the classification part 18, or the display part 19.

The display part 19 is preferably a display panel directly mounted on the cell controller 12, or is preferably the display device of a personal computer connected to the cell controller 12 via a communication cable.

The physical layout information concerns the positions of the manufacturing machines 16-1 to 16-n disposed in a factory according to the manufacturing process of products. This information is layout data on the manufacturing machines 16-1 to 16-n in the factory. The layout data is stored beforehand in, for example, the memories of the manufacturing machines 16-1 to 16-n.

The alarm information indicates, for example, the number of alarms, that is, the number of alarms about abnormalities during the manufacturing time of the manufacturing machines 16-1 to 16-n. The alarm information may be the incidence of alarms. The incidence of alarms is determined by dividing the number of alarms by a production time or the number of manufacturing machines in the manufacturing cell 11. The number of alarms or the incidence of alarms is calculated by the calculation function of the manufacturing machines 16-1 to 16-n.

The status information indicates the statuses of the manufacturing machines 16-1 to 16-n and particularly allows recognition of the occurrence of abnormalities. For example, if the manufacturing machines 16-1 to 16-n are robots, the machine information reception part 17 receives information including the communication statuses or operating speeds of the robots at predetermined intervals. This information includes data on a contact signal during communication control on the robots and data on the output signal of a position detector or a speed detector mounted in the driving motor of a robot arm part. The number of abnormalities of the robots is measured according to the history of the data, allowing calculation of the incidence of abnormalities in a unit time. The function of calculating the number of abnormalities or the incidence of abnormalities from the status information may be provided for the manufacturing machines 16-1 to 16-n, the machine information reception part 17, the classification part 18, or the display part 19.

Furthermore, the status information may include at least one of a driving parameter, a function parameter, and an operation program that are stored in the memories of the manufacturing machines 16-1 to 16-n. The driving parameter, the function parameter, and the operation program are represented by the following typical embodiment:

The driving parameter is directly associated with driving of the manufacturing machine. For example, in the case of an articulated robot operating with a servo motor acting as a driving source, the driving parameter includes a pulse count at the mastering position of each axis of the robot and a servo control parameter. Moreover, a robot controller may control peripheral equipment such as a hand, driven by the servo motor, and a spot welding gun, and thus the driving parameter also includes a parameter associated with driving of peripheral equipment.

The function parameter is a parameter to be set for performing a predetermined function of the manufacturing machine. For example, the function parameter includes network setting information and signal assignment information when the manufacturing machines are connected to the peripheral equipment and the field network via the cell controller 12. The function parameter also includes a software function and a counter accessible from the operation program. Furthermore, the function parameter includes a decision threshold for the abnormality decision function of the manufacturing machine, for example, the upper limit of the torque of the servo motor. The upper limit is set to decide reception of an overload by an articulated robot that operates with a servo motor acting as a driving source.

The operation program is programming information on command processing for a predetermined operation of the manufacturing machine. For example, in the case of an articulated robot, the operation program includes an action command for moving the arm part to an operation position, a command for notification of any external signal, and a command for reading a status of any signal. The operation program also includes operation position information and operation signal numbers. Naturally, any commands may be used as long as the commands can be registered on programs. In other words, the present invention is not limited to the programming information.

In the first embodiment, the machine information reception part 17 acquires the physical layout information from the manufacturing machines 16-1 to 16-n. The present invention is not limited to this configuration. For example, as shown in FIG. 1, the cell controller 12 of the first embodiment may include a physical layout-information setting part 20 that sets the physical layout information on the manufacturing machines 16-1 to 16-n. In this case, the machine information reception part 17 does not always need to have the function of receiving the physical layout information on the manufacturing machines 16-1 to 16-n. The classification part 18 in this state classifies the physical layout information into multiple groups, not from the machine information reception part 17, but from the physical layout-information setting part 20.

The physical layout information is preferably inputted to the physical layout-information setting part 20 by the host computer 13 or a manual operation. In a configuration where the physical layout information is acquired from the manufacturing machines 16-1 to 16-n, the manufacturing machines 16-1 to 16-n connected to the cell controller 12 may allow the machine information reception part 17 to receive the physical layout information only once.

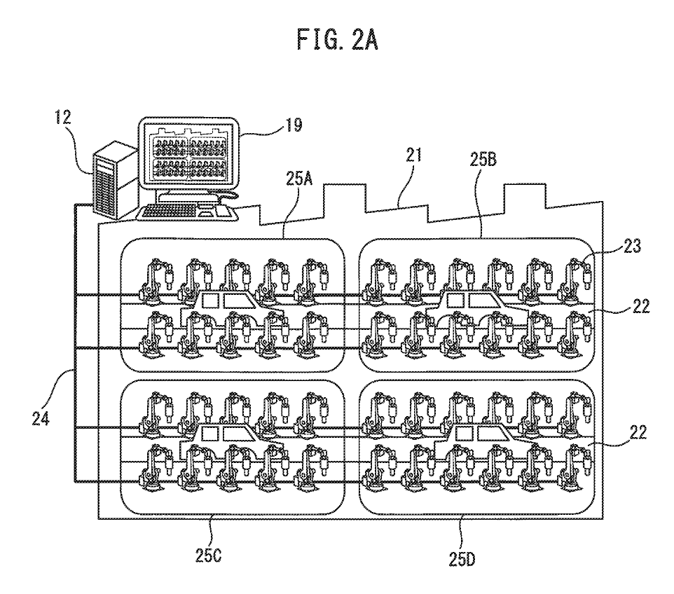

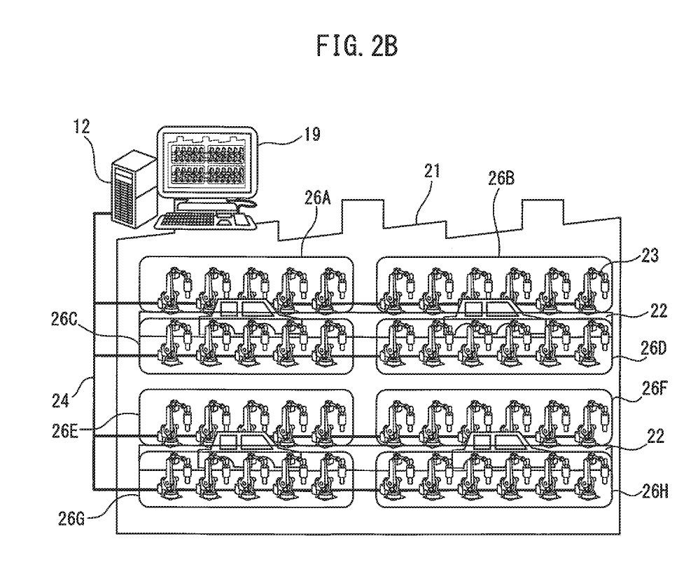

In the following specific example, as described above, physical layout information on the manufacturing machines 16-1 to 16-n is classified into multiple groups by the classification part 18. FIG. 2A schematically shows an example of classification by the classification part 18. FIG. 2B schematically shows another example of classification by the classification part 18.

For example, as shown in FIG. 2A and FIG. 2B, two assembly lines 22 for manufacturing automobiles are constructed in a factory 21. A plurality of robots 23 are disposed on both sides of each of the assembly lines 22 so as to be aligned along the assembly lines 22. The robots 23 are connected so as to communicate with the cell controller 12 through an intranet 24.

As described above, the physical layout information on the robots 23 constituting the two assembly lines 22 may be classified into four groups 25A to 25D as shown in FIG. 2A. More specifically, each of the groups 25A to 25D may include a predetermined number of robots 23 disposed in an area around an automobile on the assembly line 22.

Moreover, as shown in FIG. 2B, physical layout information on the robots 23 may be classified into eight groups 26A to 26H. More specifically, each of the groups 26A to 26H may include a predetermined number of robots 23 disposed in an area on each side of an automobile on the assembly line 22.

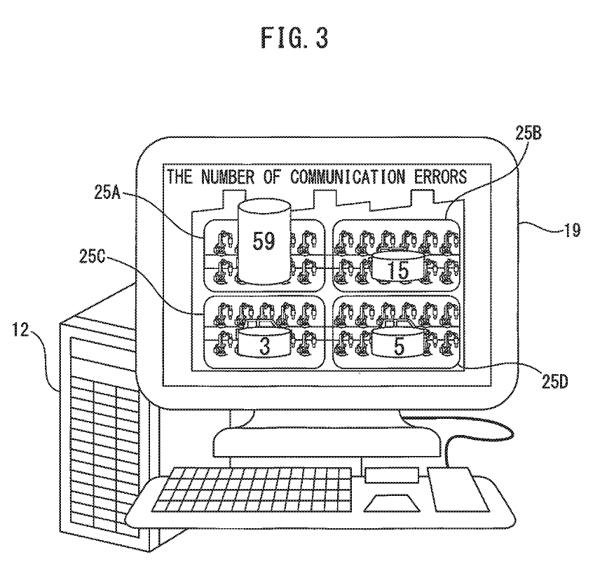

FIG. 3 schematically shows an example of the contents displayed on the display part 19 in the classification of FIG. 2A.

For example, it is assumed that the machine information reception part 17 receives communication statuses as status information on the robots 23 at the predetermined intervals. If the physical layout information on the robots 23 is classified into the four groups 25A to 25D by the classification part 18 as shown in FIG. 2A, the display part 19 displays the number of communication errors for each of the groups 25A to 25D as shown in FIG. 3. As shown in FIG. 3, the number of communication errors is preferably presented in numerical or graphical form. According to this example, the contents displayed on the display part 19 indicate that the robots 23 have a relatively large number of communication errors in the group 25A. Thus, a product manager in a building containing the cell controller 12 can predict the presence of a noise source near the area of the group 25A and immediately instruct an operator in the factory to check the presence or absence of a noise source near the area of the group 25A.

The configuration of a cell controller 12 according to a second embodiment will be specifically described below. Configurations which are different from the first embodiment (FIG. 1) will mainly be discussed. Constituent elements having the same functions as those of the first embodiment are indicated by the same reference numerals.

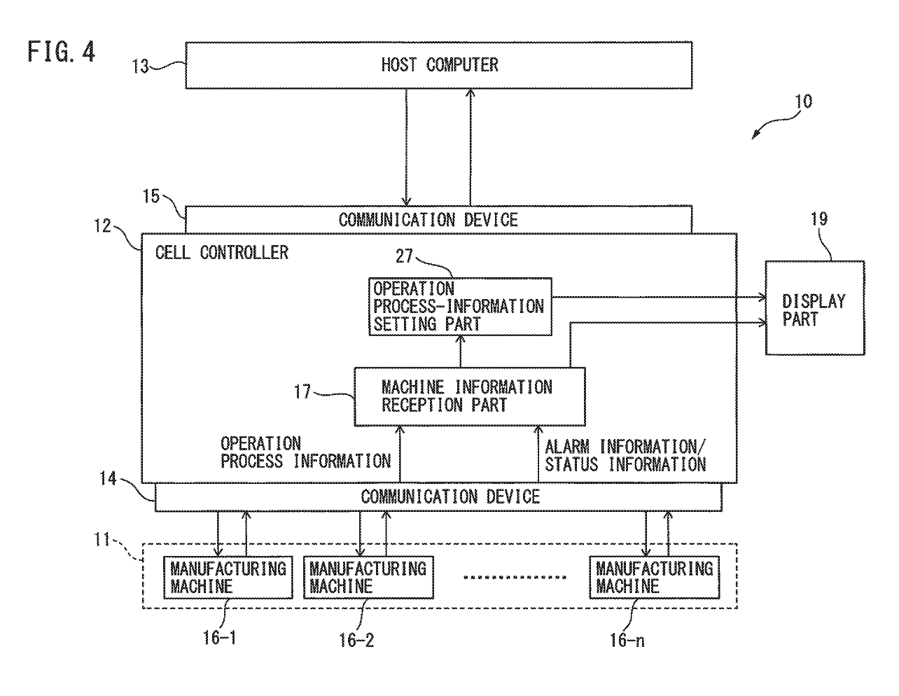

FIG. 4 is a block diagram showing a production system 10 including the cell controller 12 according to the second embodiment.

Referring to FIG. 4, the cell controller 12 of the second embodiment includes a machine information reception part 17, an operation process-information setting part 27, and a display part 19.

In the second embodiment, the machine information reception part 17 receives at least one of alarm information and status information on manufacturing machines 16-1 to 16-n and operation process information on the manufacturing machines 16-1 to 16-n.

A specific example of the alarm information and status information is identical to that of the first embodiment.

The operation process information concerns a plurality of operation processes performed by some of the manufacturing machines. This information indicates the contents of the operation processes of the respective manufacturing machines, the contents is stored beforehand in, for example, memories in the manufacturing machines 16-1 to 16-n. For example, the manufacturing machines 16-1 to 16-n may be allocated to some operation groups according to the contents of operation processes for finishing products. In this case, the contents of the operation processes of the manufacturing machines 16-1 to 16-n are stored in, for example, the memories of the manufacturing machines 16-1 to 16-n so as to identify the operation processes used for manufacturing products by means of the manufacturing machines.

Moreover, the display part 19 of the second embodiment displays an abnormality status of the manufacturing machines for each of the operation processes obtained from the operation process information. The displayed abnormality status includes the number of abnormalities or the incidence of abnormalities of the manufacturing machines, for example, a fault rate (may be called a failure rate) in each of the operation processes. The fault rate is the rate of faults or failures of machines, such as a motor, in a unit time. The fault rate is determined by, for example, dividing the number of faults or failures by a certain unit time. Thus, the machine information reception part 17 of the second embodiment preferably has the function of calculating a fault rate based on at least one of the received alarm information and status information. The calculation function may be provided for the manufacturing machines 16-1 to 16-n or the display part 19. Naturally, the calculation function may include the function of calculating the number of alarms or the incidence of alarms of the manufacturing machines in the operation processes.

In the second embodiment, the machine information reception part 17 receives the operation process information from the manufacturing machines 16-1 to 16-n. The present invention is not limited to this configuration. For example, as shown in FIG. 4, the cell controller 12 of the second embodiment may include an operation process-information setting part 27 that sets the operation process information on the manufacturing machines 16-1 to 16-n. In this case, the machine information reception part 17 does not always need to have the function of receiving the operation process information on the manufacturing machines 16-1 to 16-n. The display part 19 in this state displays an abnormality status based on at least one of the alarm information and status information that are acquired by the machine information reception part 17, for each segment of the operation process information set by the operation process-information setting part 27.

The operation process information is preferably inputted to the operation process-information setting part 27 by a host computer 13 or a manual operation. In a configuration where the operation process information is acquired from the manufacturing machines 16-1 to 16-n, the manufacturing machines 16-1 to 16-n connected to the cell controller 12 may allow the machine information reception part 17 to receive the operation process information only once.

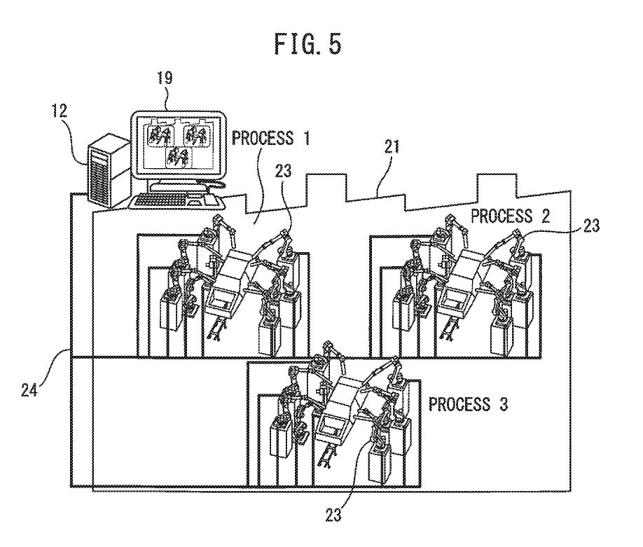

FIG. 5 schematically shows an example of the operation process information.

For example, as shown in FIG. 5, it is assumed that automobiles are manufactured through processes 1 to 3 having different operation contents in a factory 21. A plurality of robots 23 are disposed around automobiles to be worked in the processes 1 to 3. The robots 23 store information indicating which of the processes 1 to 3 is to be performed. This information serves as the operation process information. The robots 23 are connected so as to communicate with the cell controller 12 via an intranet 24.

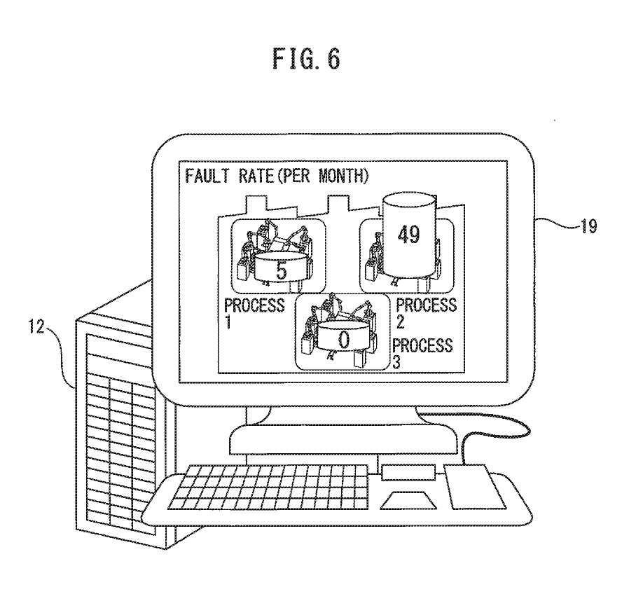

FIG. 6 schematically shows an example of contents displayed on the display part 19 based on the operation process information shown in FIG. 5.

For example, it is assumed that the machine information reception part 17 receives the operation process information on the robots 23. As shown in FIG. 6, the display part 19 displays a fault rate for each of the processes 1 to 3. The fault rates are preferably presented in numerical or graphical form as shown in FIG. 6. According to this example, the contents displayed on the display part 19 indicate that the robots 23 have a relatively high fault rate in process 2. Thus, a product manager in a building containing the cell controller 12 can predict that the robots 23 have a high operation duty in process 2 and immediately instruct an operator in the factory to adjust a cycle time according to other processes or examine the addition of robots.

As described above, in the cell controllers 12 (See FIGS. 1 and 4) of the first and second embodiments, at least one of the alarm information and status information is received from the manufacturing machines 16-1 to 16-n by the machine information reception part 17. Moreover, the cell controller 12 acquires physical layout information or operation process information on the manufacturing machines 16-1 to 16-n from the manufacturing machines 16-1 to 16-n or the setting parts (20, 27) in the cell controller 12.

In the case of the cell controller 12 (FIG. 1) according to the first embodiment, particularly the acquired physical layout information on the manufacturing machines 16-1 to 16-n is classified into the multiple groups by the classification part 18. An abnormality status based on the received alarm information or status information is displayed on the display part 19 for each group of the physical layout information on the manufacturing machines 16-1 to 16-n. The displayed abnormality status for each group includes the number of alarms and the incidence of alarms of the manufacturing machines for each group, that is, each area.

Thus, in the first embodiment, the abnormality status of the manufacturing machines can be displayed in groups classified based on the physical layout information on the manufacturing machines. This can easily determine that an abnormality of the manufacturing machine is caused by the environment of a specific area.

In the case of the cell controller 12 (FIG. 4) according to the second embodiment, the abnormality status based on the received alarm information or status information is displayed on the display part 19 for each of the operation processes of the operation process information. The displayed abnormality status for each of the operation processes includes the fault rate or failure rate of the manufacturing machines in each of the operation processes.

Thus, in the second embodiment, the abnormality status of the manufacturing machines can be displayed for each of the operation processes included in the operation process information on the manufacturing machines. This can easily determine that an abnormality of the manufacturing machine is caused by operation conditions in a specific operation process.

Another embodiment will be described below.

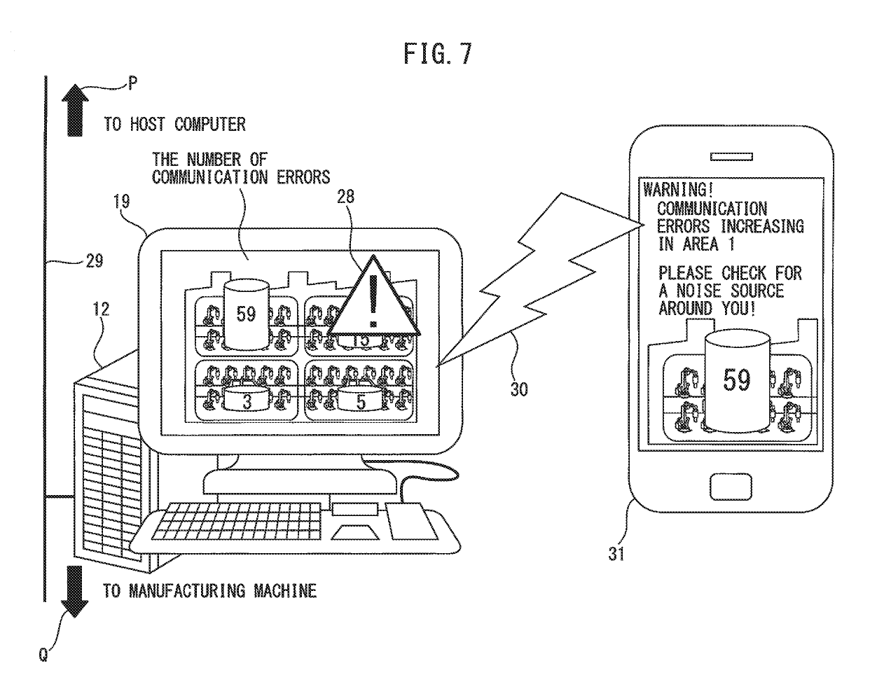

FIG. 7 schematically shows the function of a cell controller 12 according to the embodiment. In FIG. 7, the contents displayed on the display part 19 shown in FIG. 3 are used to illustrate the function of the cell controller according to the embodiment.

In the first and second embodiments, the display part 19 displays the abnormality status of the manufacturing machines 16-1 to 16-n, for example, the number of communication errors or a fault rate for each group or each operation process (See FIGS. 3 and 6).

However, the cell controller 12 preferably includes a warning output part (not shown) that outputs a warning if the number of abnormalities or the incidence of abnormalities exceeds a predetermined threshold, in addition to the display part 19 that displays the abnormality status, for example, the number of abnormalities or the incidence of abnormalities.

For example, upon the output of a warning, as shown in FIG. 7, the warning output part of the cell controller 12 preferably displays a large warning mark 28 on the screen of the display part 19. Moreover, as indicated by arrow P and arrow Q in FIG. 7, the warning output part of the cell controller 12 preferably notifies a host computer 13 or manufacturing machines under abnormal conditions about the warning through a network cable 29. Furthermore, as shown in FIG. 7, the warning output part of the cell controller 12 preferably displays the contents of the warning on the display screen of a mobile terminal 31 held by an operator in a factory through radio communications 30 using radio waves or infrared rays. These methods can quickly notify a product manager outside the factory and an operator in the factory about an abnormality of the manufacturing machine in a specific area or a specific operation process.

The present invention was described above according to the typical embodiments. A person skilled in the art could understand that the embodiments can be changed and various other changes, omissions, and additions may be made without departing from the scope of the present invention.

According to one embodiment of the present disclosure, an abnormality status can be displayed for each group classified based on physical layout information on manufacturing machines. This can easily determine that an abnormality of the manufacturing machine is caused by the environment of a specific area.

According to another embodiment of the present disclosure, an abnormality status of the manufacturing machines can be displayed for each operation process included in operation process information on the manufacturing machines. This can easily determine that an abnormality of the manufacturing machine is caused by operation conditions in a specific operation process.

According to still another embodiment of the present disclosure, a product manager outside a factory or an operator in the factory can be immediately informed of an abnormality of the manufacturing machine in a specific area or a specific operation process.

1. A cell controller that controls a plurality of manufacturing machines, the cell controller is connected so as to communicate with a host computer, wherein
the cell controller comprising:
a machine information reception part that receives at least one of alarm information on the manufacturing machines, status information on the manufacturing machines, and receives physical layout information on the manufacturing machines;
a classification part that classifies the physical layout information received by the machine information reception part into a plurality of groups; and
a display part that displays an abnormality status based on the alarm information or status information on the manufacturing machines, for each of the groups of the physical layout information classified by the classification part.

2. A cell controller that controls a plurality of manufacturing machines, the cell controller is connected so as to communicate with a host computer, wherein
the cell controller comprising:
a machine information reception part that receives at least one of alarm information on the manufacturing machines and status information on the manufacturing machines, and receives operation process information on the manufacturing machines; and
a display part that displays an abnormality status based on the alarm information or status information on the manufacturing machines, for each operation process of the operation process information received by the machine information reception part.

3. A cell controller that controls a plurality of manufacturing machines, the cell controller is connected so as to communicate with a host computer, wherein
the cell controller comprising:
a machine information reception part that receives at least one of alarm information on the manufacturing machines and status information on the manufacturing machines;
a physical layout-information setting part that sets physical layout information on the manufacturing machines;
a classification part that classifies the physical layout information into a plurality of groups; and
a display part that displays an abnormality status based on the alarm information or status information on the manufacturing machines, for each of the groups of the physical layout information classified by the classification part.

4. A cell controller that controls a plurality of manufacturing machines, the cell controller is connected so as to communicate with a host computer, wherein
the cell controller comprising:
a machine information reception part that receives at least one of alarm information on the manufacturing machines and status information on the manufacturing machines;
an operation process-information setting part that sets operation process information on the manufacturing machines; and
a display part that displays an abnormality status based on the alarm information or status information on the manufacturing machines, for each operation process included in the operation process information.

5. The cell controller according to claim 1, further comprising a warning output part that outputs a warning if the number of abnormalities or an incidence of abnormalities exceeds a predetermined threshold, wherein the number of abnormalities or the incidence of abnormalities indicates an abnormality status of the manufacturing machines for each of the groups of the classified physical layout information.

6. The cell controller according to claim 2, further comprising a warning output part that outputs a warning if the number of abnormalities or an incidence of abnormalities exceeds a predetermined threshold, wherein the number of abnormalities or the incidence of abnormalities indicates an abnormality status of the manufacturing machines for each operation process included in the operation process information.

7. The cell controller according to claim 3, further comprising a warning output part that outputs a warning if the number of abnormalities or an incidence of abnormalities exceeds a predetermined threshold, wherein the number of abnormalities or the incidence of abnormalities indicates an abnormality status of the manufacturing machines for each of the groups of the classified physical layout information.

8. The cell controller according to claim 4, further comprising a warning output part that outputs a warning if the number of abnormalities or an incidence of abnormalities exceeds a predetermined threshold, wherein the number of abnormalities or the incidence of abnormalities indicates an abnormality status of the manufacturing machines for each operation process included in the operation process information.
